(19) United States
(12) Patent Application Publication
(10) Pub. No.: US 2007/0088589 A1
(43) Pub. Date: Apr. 19, 2007

(54) Method and system for assessing automation package readiness and and effort for completion

(75) Inventors: Peter F. Ciprino, Staatsburg, NY (US); Richard G. Shomo, Rhinebeck, NY (US); David R. Scott, Ontario (CA)

Correspondence Address: John E. Campbell;IBM Corporation Intellectual Property Law, 2455 South Road - P386, Poughkeepsie, NY, 12601, US

(73) Assignee: International Business Machines Corporation, Armonk, NY (US)

(21) Appl. No.: 11/251,948

(22) Filed: Oct. 17, 2005

(51) Int. Cl. G06F 9/46

(52) U.S. Cl. 705/8

(57) ABSTRACT

A system, method and program product for evaluating workflows includes formulating a list of categories for workforce projects to be evaluated. A list is then formulated of questions for each category. Ranges are set up and then applied to the categories. Base line days, a multiplier, and a weight are assigned to each range. A number of assets is assigned for the workflow being evaluated. A derived value is assigned to each range; and a range to each category pending evaluation is input. These standardized evaluation criteria are thus established for evaluating workflows.

### FIELD OF THE INVENTION

This invention relates to computer programs for the assessment of workflows, and particularly to the assessment of inputs according to predefined criteria and sizing of results for the evaluation of workflows.

### BACKGROUND OF THE INVENTION

The invention allows for the workflows associated currently with Tivoli Intelligent Orchestrator available from International Business Machines Corporation, Armonk, N.Y., to be assessed for completeness according to predefined criteria and the delta between 100% complete and the assessed rating to be sized. There exist tools that perform specific types of validation for specific types of technology but no one technology can be used to assess the current state of workflows and then applying a sizing. The invention allows for the filling of this whitespace.

No method or system currently exists to properly evaluate the cost and readiness for an automation package containing workflows for the provisioning of servers and network devices like routers and load balancers. Organizations involved with the delivery of workflows have a need to properly evaluate existing open source automation packages in order to reduce development and customer cost. Currently developers or system engineers would need to use a process of best guesses or non repeatable methods to estimate the completeness of workflows. Workflows are also a new entry into the open source paradigm and unfortunately few, if any, persons have the past experience to evaluate the readiness and cost of re-using open source workflows. The invention will allow for a standardized structured method to be followed that will produce consistent results.

Not having a repeatable method and structured system can and will cause inconsistency in development sizing and project schedules potentially leading to the reduction in customer satisfaction and development credibility.

U.S. Pat. No, 6,003,011 issued Dec. 14, 1999 to Sarin et al. for WORKFLOW MANAGEMENT SYSTEM WHEREIN AD-HOC PROCESS INSTANCES CAN BE GENERALIZED discloses, in workflow management software, task objects describing a successfully completed workflow process instances are copied. The copied task objects are then generalized in the relevant variables thereof, so that the entire workflow process is thus generalized for direct re-use in an amended workflow process definition.

U.S. Pat. No. 6,028,997 issued Feb. 22, 2000 to Laymann et al. for METHOD OF GENERATING AN IMPLEMENTATION OF REUSABLE PARTS FROM CONTAINERS OF A WORKFLOW PROCESS-MODEL discloses a method for automatically generating an implementation of input and output container reusable parts for a process model managed and executed by at least one computer system. The method of generating comprises an analysis of the specifications of said process model. Based on this analysis the method generates the associated input container reusable parts and associated output container reusable parts as implementations of said input and output containers.

U.S. Pat. No. 6,658,644 B1 issued Dec. 2, 2003 to Bishop et al. for SERVICES-BASED ARCHITECTURE FOR A TELECOMMUNICATIONS ENTERPRISE discloses a system and method for developing software applications for reuse. Defined first, a service which is a well-known dynamically callable software program that is currently in existence and is running somewhere in the business concern or enterprise on a computer network.

U.S. Patent Application Publication No. US 2003/0055672 A1 published Mar. 20, 2003 by Inoki et al. for METHOD OF DEFINING FUNCTIONAL CONFIGURATION OF BUSINESS APPLICATION SYSTEM discloses a method which defines a functional configuration of business application system. The method is capable of reducing the time required to carry out a requirements definition step and of defining a unified functional configuration to efficiently share and reuse common components.

U.S. Patent Application Publication No. US 2003/0200527 A1 published Oct. 23, 2003 by Lynn et al. for DEVELOPMENT FRAMEWORK FOR CASE AND WORKFLOW SYSTEMS discloses a workforce framework providing common objects and business processes for creation of an enterprise-wide workflow processing system.

U.S. Patent Application Publication No. US 2003/0208367 A1 published Nov. 6, 2003 by Aizenbud-Reshef et al. for FLOW COMPOSITION MODEL SEARCHING discloses an arrangement and method for flow composition model searching by holding in a repository, records of flow composition models containing information representative of predetermined flow composition model characteristic thereof, specifying information representative of desired ones of the predetermined flow composition model characteristics, and retrieving from the repository flow control model records matching the specified information.

U.S. Patent Application Publication No. US 2004/0103014 A1 published May 27, 2004 by Teegan et al. for SYSTEM AND METHOD FOR COMPOSING AND CONSTRAINING AUTOMATED WORKFLOW discloses a system and method wherein workflows can be used, created, modified and saved from within a user's working environment. An existing workflow saved as a practice may be reused or modified.

U.S. Patent Application Publication No. US 2004/0177335 A1 published Sep. 9, 2004 by Beisiegel et al. for ENTERPRISE SERVICES APPLICATION PROGRAM DEVELOPMENT MODEL discloses a development model for architecting enterprise systems which presents a service-oriented approach which leverages open standards to represent virtually all software assets as services including legacy applications, packaged applications, J2EE components or web services. Individual business application components become building blocks that can be reused in developing other applications.

U.S. Patent Application Publication No. US 2004/0181418 A1 published Sep. 16, 2004 by Petersen et al. for PARAMETERIZED AND REUSABLE IMPLEMENTATIONS OF BUSINESS LOGIC PATTERNS discloses flexible implementations of business logic in a business application. General and reusable business logic is implemented such that customized solutions for business applications are easier to develop. Binding properties in business entities to various logic implementations is utilized to reuse the business logic.

SKILL BASED ROUTING VS. SKILL SET SCHEDULING, a Pipkins White Paper by Dennis Cox, 1995-2000 discloses workforce management systems designed to handle all levels of complexity in an intelligent and coherent way by being able to accurately represent the manner in which ACD distributes calls to the agents and by reflecting the management drivers of efficiency and effectiveness.

SKILLS-BASED ROUTING IN THE MODERN CONTRACT CENTER, a Blue Pumpkin Solutions White Paper by Vijay Mehrotra, Revised Apr. 14, 2003, discusses call centers having management defined queues, established service level expectations, required agent skills, realistic guesses at the traffic that will be coming through each new channel, and key business questions about how to route contacts through the center.

WORKFORCE MANAGEMENT FOR SKILLS-BASED ROUTING: THE NEED FOR INTEGRATED SIMULATION, an IEX Corporation White Paper by Paul Leamon, 2004, discusses accurate forecasting and scheduling needed in order to consistently meet and exceed service level goals without significantly overstaffing.

### SUMMARY OF THE INVENTION

The object of this invention is to provide a method and system to evaluate the readiness and effort for completion of an automation package to be used by, but not limited to, the develop community and system engineers on provisioning type projects. The invention as described below will contain the method for which the automation package will be assessed and the system to apply that method. Each asset within an automated package will be assessed as a group. An asset will be defined as a file within an automation package that can be, but not limited to, workflow files, documentation files or java class files. The invention contains the explanation of the unique method to derive the rating and sizing of an automation package and the system in which to implement the method is also described herein.

The invention described below can also be adjusted to support other types of source code assessment like, but not limited to, Java, Visual Basic, and Perl scripts.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic diagram of a system usable with the present invention:

FIG. 2 is a flowchart of the method of the present invention:

FIG. 3 is a flowchart of the program using the formulas of the present invention:

FIG. 4 shows a category with associated questions along with the user score, weight, and calculated score of the method and formula calculations of FIGS. 1 and 2;

FIG. 5 shows a sample input screen for the ranges, calculated days, base line days, and asset multiplier of the method and formula calculation of FIGS. 1 and 2;

FIG. 6 shows the input for non unit test and DIT test activity of the method and formula calculations of FIGS. 1 and 2;

FIG. 7 shows the input screen for the assignment of weights, complexity, and whether the category was assigned an offset of the method and formula calculations of FIGS. 1 and 2;

FIG. 8 shows the input screen for the complexity values used as a multiplier to the days of the method and formula calculations of FIGS. 1 and 2;

FIG. 9 shows a sample assessment of a automation package with 20 assets being evaluated;

FIG. 10 shows questions for the General Information category for one embodiment of the method of FIG. 1;

FIG. 11 shows questions for the Documentation category for one embodiment of the method of FIG. 1;

FIG. 12 shows questions for the Testing Verification category for one embodiment of the method of FIG. 1;

FIG. 13 shows questions for the General Development category for one embodiment of the method of FIG. 1;

FIG. 14 shows questions for the Naming Conventions category for one embodiment of the method of FIG. 1;

FIG. 15 shows questions for the Code category for one embodiment of the method of FIG. 1; and

FIG. 16 shows questions for the Security category for one embodiment of the method of FIG. 1.

The detailed description explains the preferred embodiments of the invention, together with advantages and features, by way of example with reference to the drawings.

### DETAILED DESCRIPTION OF THE INVENTION

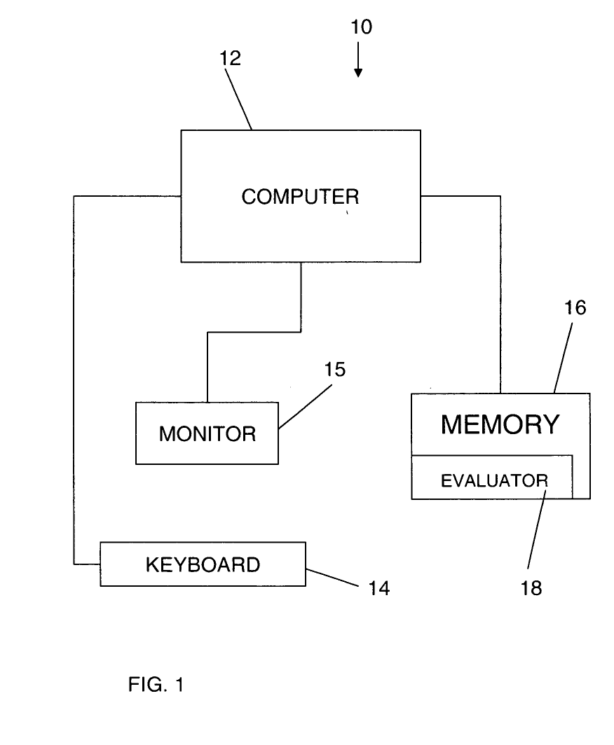

FIG. 1 is an illustration of a system 10 for using the present invention and includes a computer 12 having a monitor 15 and an input device such as a keyboard 14. The computer 12 has or is connected to a memory 16 for holding data and software programs such as the Evaluator program 18 of the present invention. As is well understood, the memory may be hardware memory such as a Direct Access Storage Device (DASD) including a harddrive, tape drive, flash card memory, or any other memory for holding data and software programming. These components are well understood in the art, and will not be discussed further.

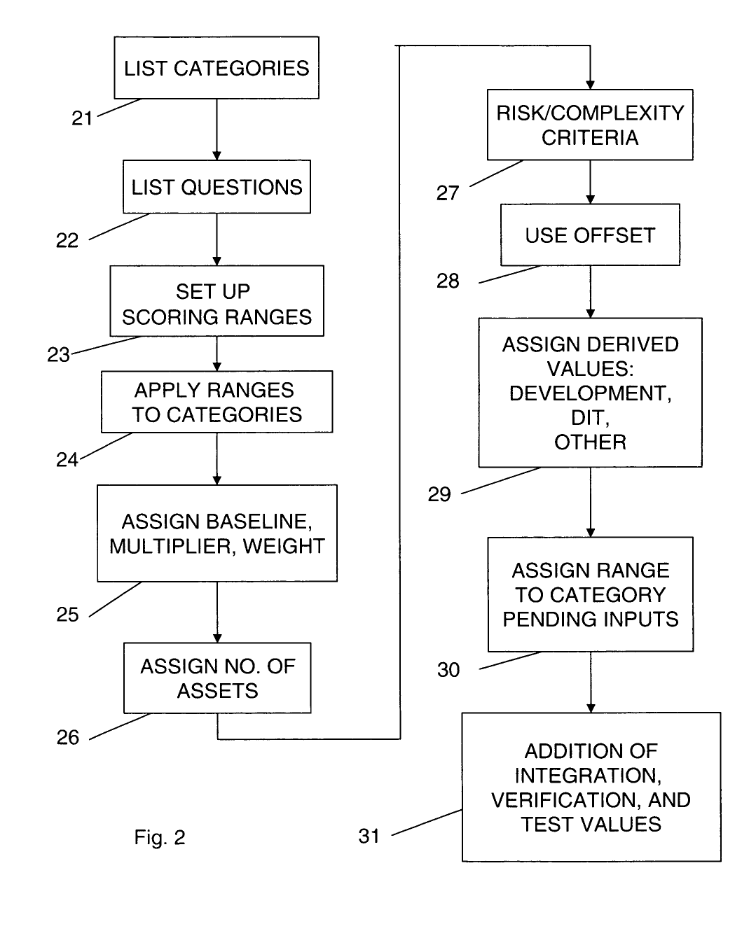

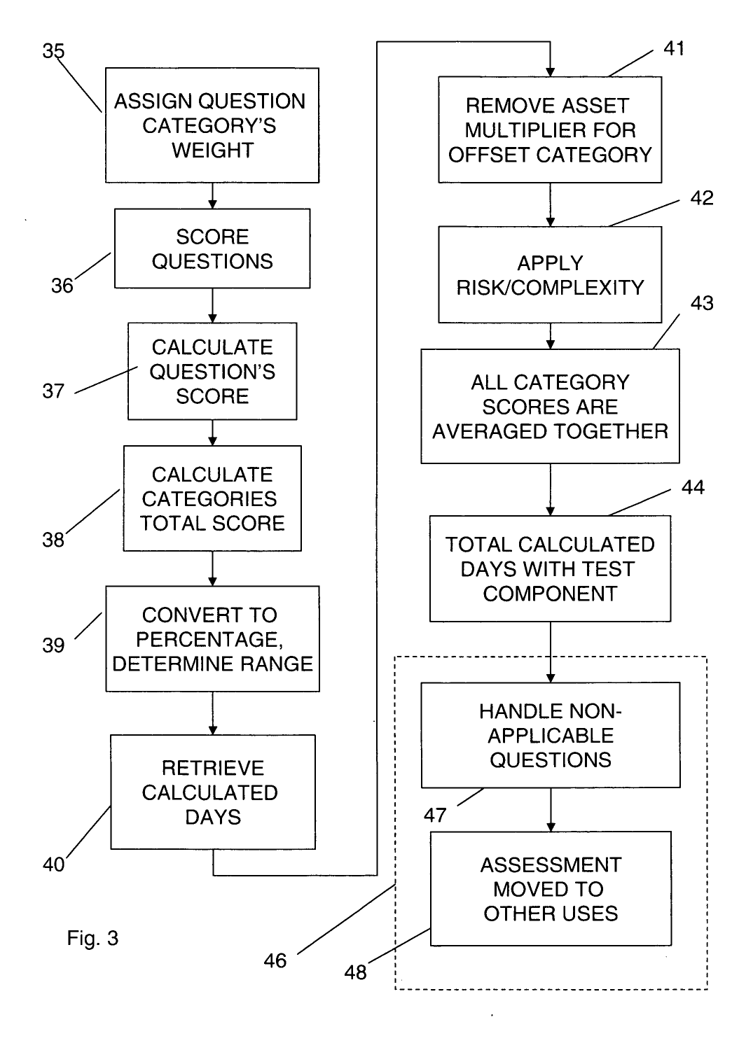

The capabilities of the present invention can be implemented in software, firmware, or hardware. The method of the Evaluator program 18 for the evaluation contains the following work items shown in the flowchart of the method shown in FIG. 1, and which will be used as inputs into the formula for evaluation shown in the flowchart of FIG. 2.

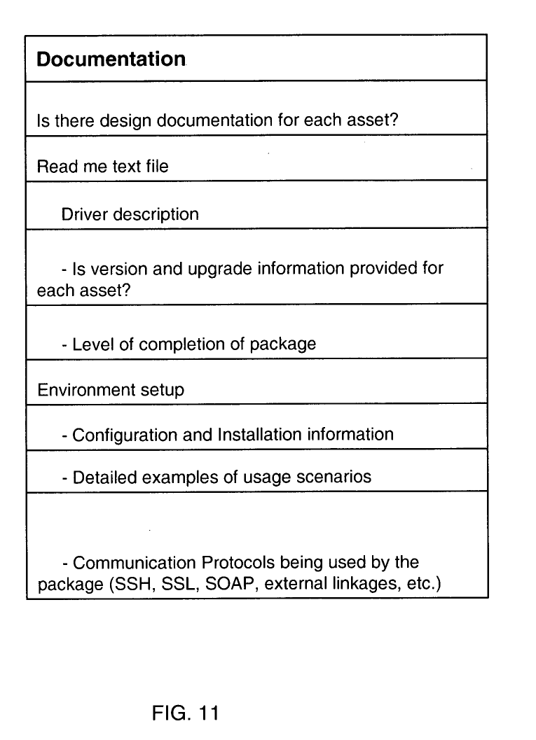

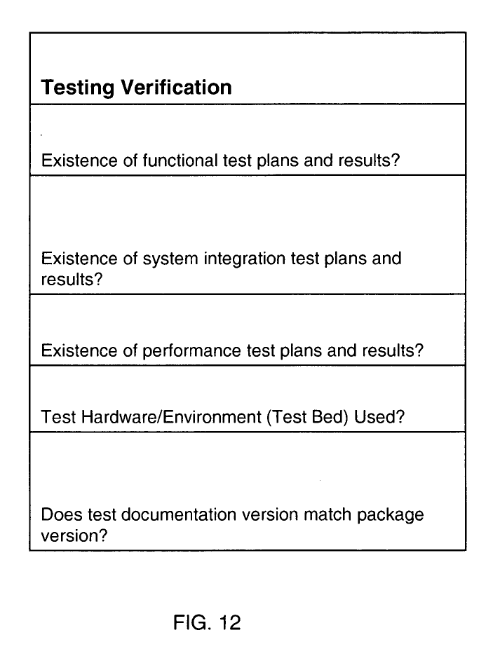

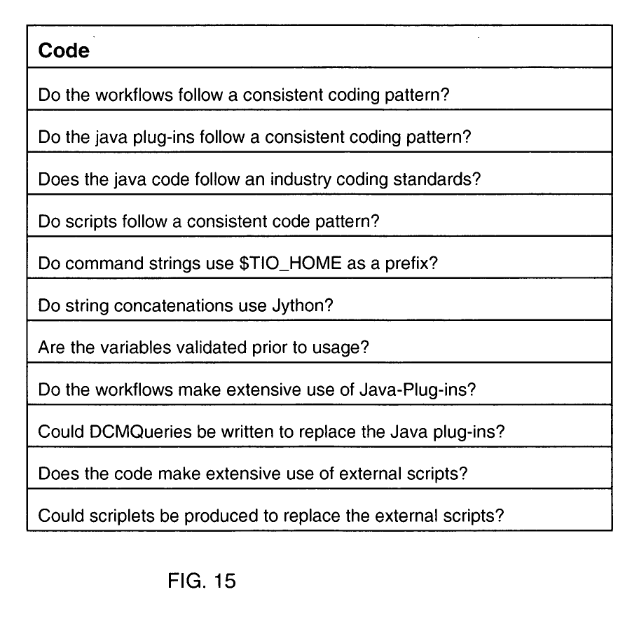

The method is shown in the flowchart of FIG. 1. At 21, the evaluator or user of the Evaluator program 18 establishes a list of categories that will cover the breadth of the automation package of the program 18. In one embodiment, these categories include titles such as Documentation, Test Verification, Naming Conventions, and Coding. (See FIGS. 11, 12, 14, and 15). The categories are created by engaging subject matter experts from workflow projects to be evaluated by program 18. At 22, the evaluator or user establishes a list of questions under each of the categories that covers the breadth of that category.

At 23, five scoring ranges are set up. In one embodiment, the scoring ranges are: 95 through 100, 75 through 94, 50 through 74, 25 through 49, and 0 through 24.

At 24, the ranges at 23 are applied to three categories of scoring including Development resources, Development Integration Test (DIT) resources and other resources (Non-development work) as follows: At 25, each range of 23 will be assigned a base line cost in days. Each range set up at 23 will be assigned a multiplier to be used per asset being evaluated. Also, each category listed at 21 will be assigned a weight determined at the creation of the evaluation.

At 26, the evaluator or user will supply the number of assets. At 27, high, medium and low risk/complexity criteria will be used to potentially add time to the overall evaluation. For instance, coding categories may be rated as high complexity while documentation may be rated as low complexity. At 28, an offset may be assigned to any category listed at 21 when a particular category is deemed not to be adjusted by the number of assets.

At 29, each range set up at 23 is assigned a derived value to be used throughout the evaluation as follows:
Development=Dev Base line days (from 25)+DIT (to be explained)+<# of Assets (from 26)×Asset multiplier (from 25))>
DIT=DIT Base line days (from 25)+<# of Assets (from 26)×Asset multiplier (from 25)>
Other=Straight base line days (from 25).

At 30, each category assigned at 21 will be assigned one of the ranges from 23 pending the evaluation inputs. In one embodiment at 31, the method of FIG. 2 allows for the addition of an integration, verification and test value to be used to complete the evaluation.

FIG. 2 is a flowchart of the formula used in the Evaluator program 18, and uses the work items of the method of FIG. 1 as inputs.

At 35, each question listed at 22 of FIG. 1 is assigned its category's weight at 25. At 36, the questions are scored by the user of the assessment in percentages. At 37, the question's score assigned at 36 is then calculated by taking the category weight multiplied by the user score. At 36, if the user scores a question with a “NA” (Not Available), then at 37, the system will score that question so as to not penalize the total category score. At 38, the category's total score will be determined by the average of the weighted question score. At 39, the category score will be turned into a percentage of the weighted score to be presented to the evaluation user. The category score is used to determine what range entered at 23 will be used to calculate projected days. At 40, the range determined at 38 to determine the calculated days for that range is retrieved.

At 41, if the category is defined as an offset category as discussed at 28, the asset multiplier is removed. At 42, the calculated days from 40 and 41 have the risk/complexity assigned at 27 applied for that category. At 43, all the category scores are averaged together. At 44, all the category calculated days from 43 are totaled together with the addition of the test component found at 31 of FIG. 1.

In one embodiment, the formula algorithm at 46 includes optional functions. At 47, the formula program for FIG. 2 handles questions marked as not applicable to the evaluation. At 48, all baselines are configurable so the assessment can be moved from automation packages to other uses.

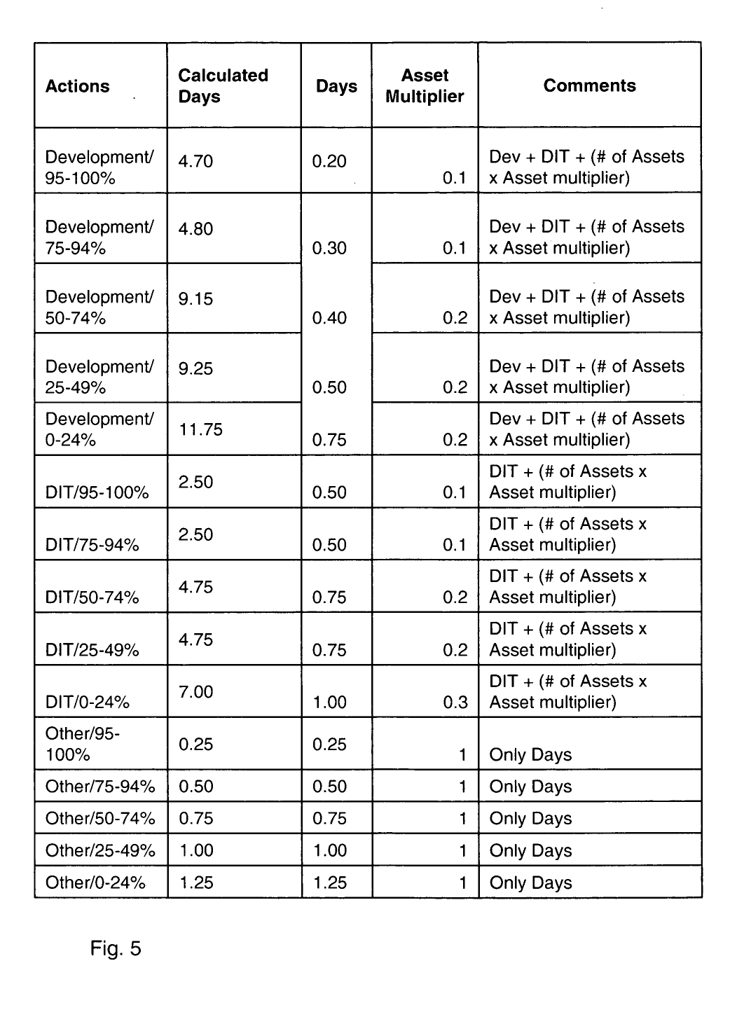

The system 10 of FIG. 1 includes for several user interfaces displayed on the monitor 16 for input by the keyboard 14. The system 10 handles the input set forth in the method. These inputs include the ranges input at 23, scoring categories at 24, base line days, asset multiplier, and category weights at 25, number of assets at 26, risk/complexity values at 27 and offset values at 28. The system 10 at 29 calculates the actual days for each range per scoring category to be used in the final assessment. This is shown at FIG. 5.

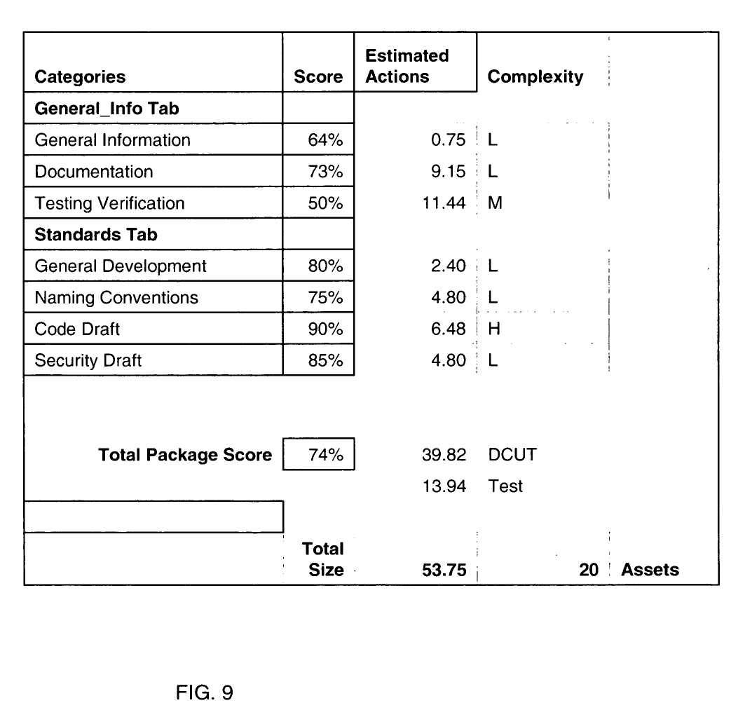

The system 10 will collect user input for the questions at 22 defined in the method and tabulate the actual question and category scores of 37, 38 and 39. The final scores per category will be displayed to the user on monitor 15 in the form of a read only screen. The range at 23 will be determined by the category score at 40 and the system 11 will apply the offset at 41 checks and balances as well as the applying the risk/complexity factor at 42. The final tabulations 43, 44 and 31 will be displayed to the user along with the number of assets evaluated at 26 as shown in FIG. 9. The final results are displayed as the following: Percent complete; Total days; Number of Assets.

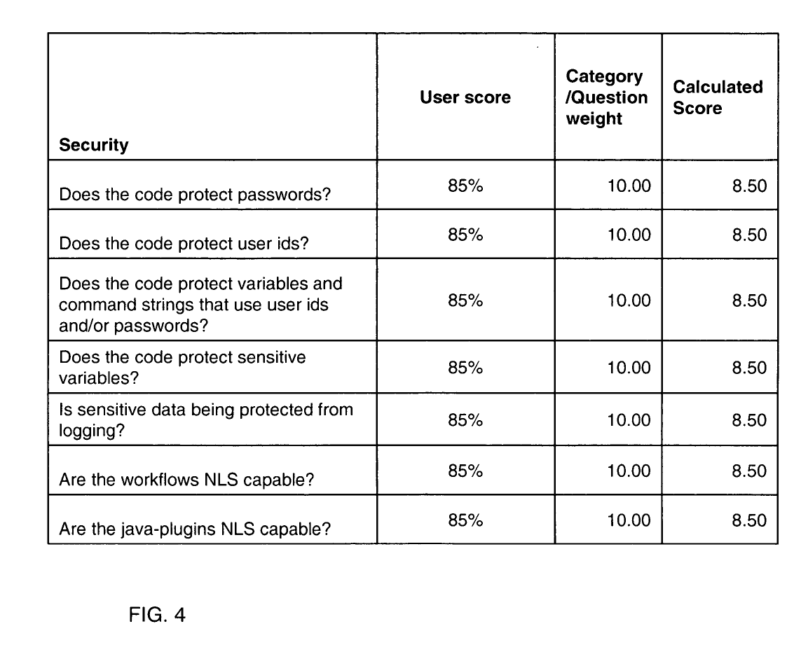

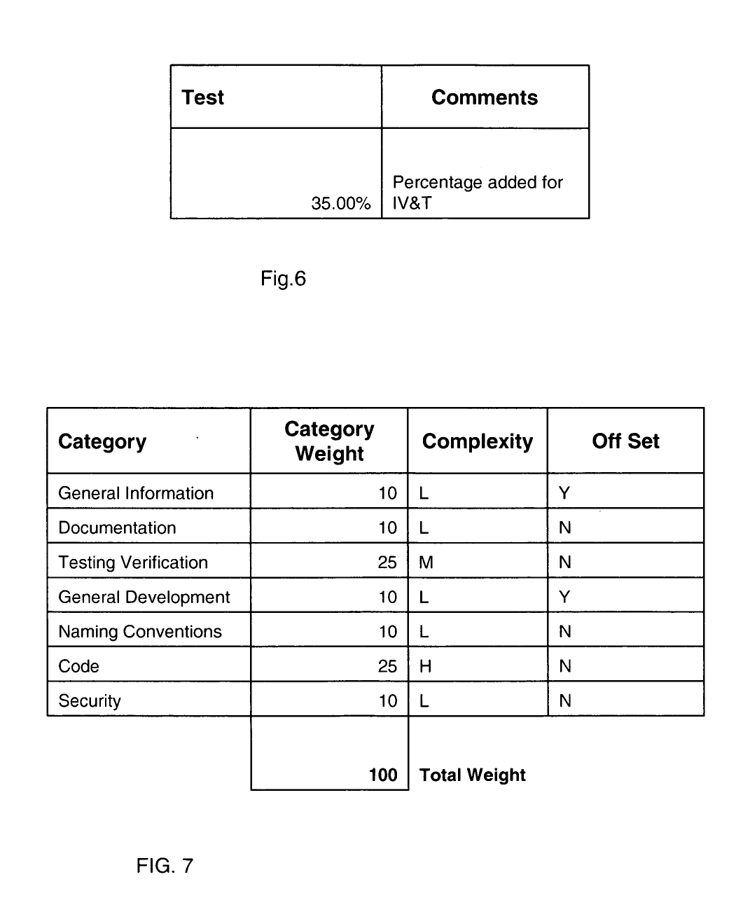

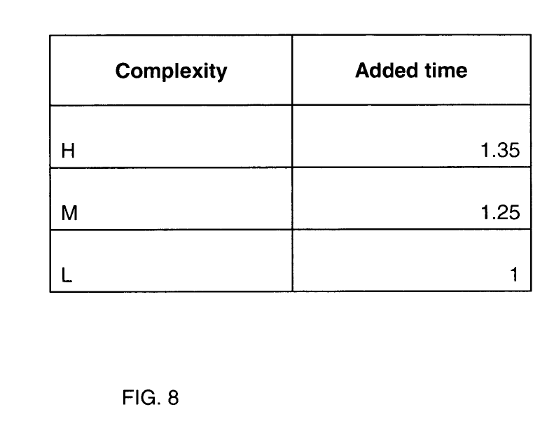

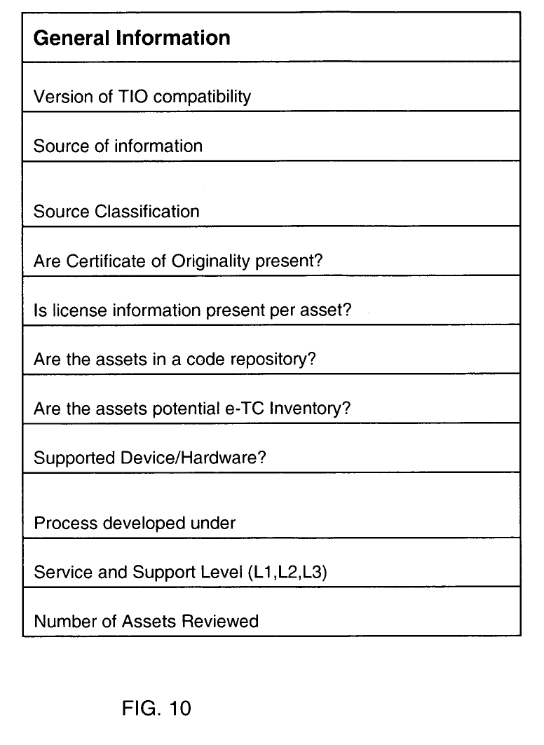

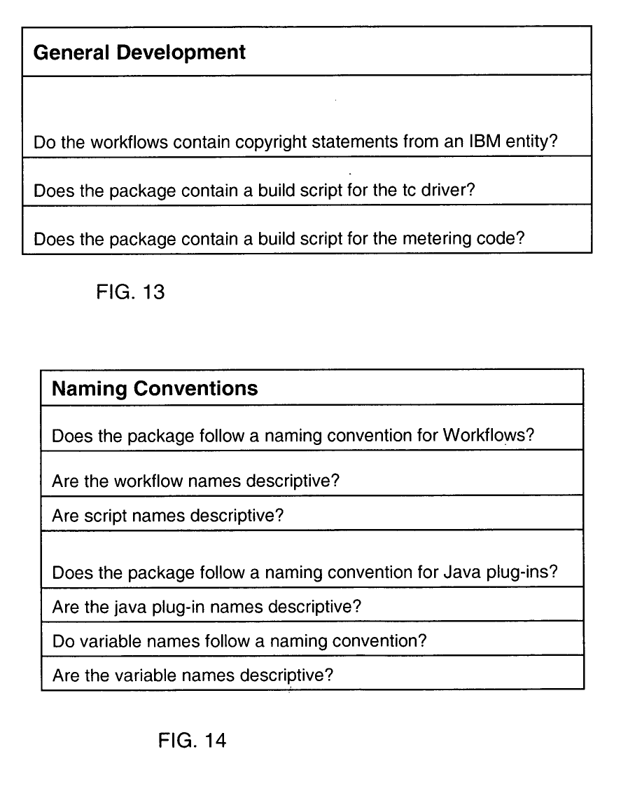

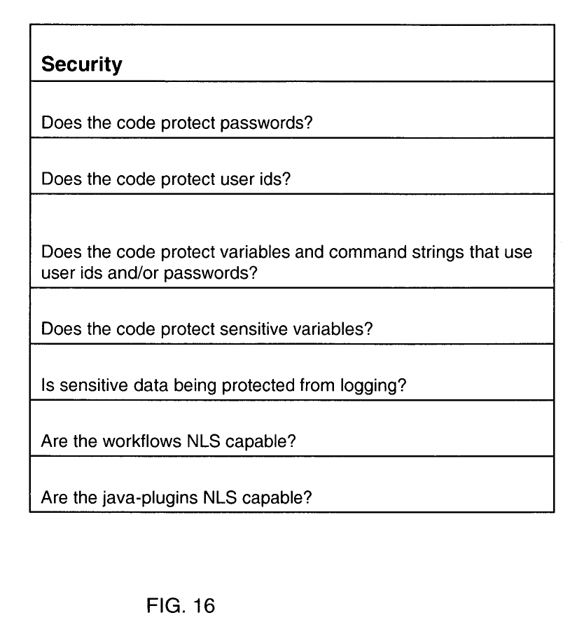

FIG. 4 shows a category with associated questions along with the user score, weight, and calculated score. FIG. 5 shows a sample input screen for the ranges, calculated days, base line days, and asset multiplier. FIG. 6 shows the input for non-unit test and DIT test activity. FIG. 7 shows the input screen for 25, 27 and 28 for the assignment of weights, complexity, and whether the category was assigned an offset. FIG. 8 shows the input screen for the complexity values at 27 to be used as a multiplier to the days. FIG. 9 shows a sample assessment of an automation package with 20 assets being evaluated. FIGS. 10-12 show the categories and questions for Screen 1 input at 21 and 22. FIGS. 13-16 show the categories and questions for Screen 2 input at 21 and 22.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for evaluating workflows comprising:
formulating a list of categories for workforce projects to be evaluated;
formulating a list of questions for each category;
setting up ranges and applying them to the categories;
assigning base line days, a multiplier, and a weight to each range;
assigning a number of assets for the workflow being evaluated;
assigning a derived value to each range; and
assigning a range to each category pending evaluation input;
whereby standardized evaluation criteria are established for evaluating workflows.

2. The method according to claim 1 further comprising assigning a risk/complexity criteria adder to the overall evaluation.

3. The method according to claim 1 further comprising assigning an offset value to a particular category wherein said particular category is not adjusted by the number of assets.

4. The method according to claim 1 further comprising adding integration, verification, and test values to the evaluation of workflows.

5. The method of claim 1 wherein said derived values comprise development values calculated by adding base line days to the sum of Development Integration Test (DIT) resources and the number of assets times an asset multiplier.

6. The method of claim 1 further comprising:
scoring said questions for a workflow to be evaluated;
calculating each question's score by multiplying the question's score times the weight assigned to the category for that question;
totaling the total score for each of said categories;
converting said total score for each category to a percentage of the weighted score;
using said percentage to retrieve a range value for said category;
using said retrieved range value to retrieve said base line days for said retrieved range value;
averaging together the total scores of all categories to give a total of days for the workflow being evaluated.

7. The method of claim 6 wherein certain of said questions are removed from the calculation of the question's score by indicating said certain questions are indicated as being non-applicable.

8. A system for evaluating workflows comprising:
A computer having an input device for receiving input data and an output device for displaying an evaluation of a workflow;
a list of categories for workforce projects to be evaluated input on said input device;
a list of questions for each category input on said input device;
ranges input on said input device and applied to categories by said computer;
base line days, a multiplier, and a weight for each range input on said input device;
a number of assets input on said input device and assigned to said workflow to be evaluated by said computer;
a derived value by said computer for each range; and
a range assigned by said computer to each category pending evaluation input;
whereby standardized evaluation criteria are established for evaluating workflows.

9. The system according to claim 8 further comprising a risk/complexity criteria adder input on said input device and assigned by said computer to the overall evaluation.

10. The system according to claim 8 further comprising an offset value input on said input device and assigned to a particular category by said computer wherein said particular category is not adjusted by the number of assets.

11. The system according to claim 8 further comprising integration, verification, and test values input on said input device and assigned by said computer to the evaluation of workflows.

12. The system of claim 8 wherein said derived values comprise development values calculated by adding base line days to the sum of Development Integration Test (DIT) resources and the number of assets times an asset multiplier.

13. The system of claim 8 further comprising with said computer:
scoring said questions for a workflow to be evaluated;
calculating each question's score by multiplying the question's score times the weight assigned to the category for that question;
totaling the total score for each of said categories;
converting said total score for each category to a percentage of the weighted score;
using said percentage to retrieve a range value for said category;
using said retrieved range value to retrieve said base line days for said retrieved range value;
averaging together the total scores of all categories to give a total of days for the workflow being evaluated.

14. The system of claim 13 wherein certain of said questions are removed from the calculation by said computer of the question's score by indicating on said input device that said certain questions being indicated as being non-applicable.

15. A program product usable with a system for evaluating a workflow, said program product comprising:
a computer readable medium having recorded thereon computer readable program code performing the method comprising:
formulating a list of categories for workforce projects to be evaluated;
formulating a list of questions for each category;
setting up ranges and applying them to the categories;
assigning base line days, a multiplier, and a weight to each range;
assigning a number of assets for the workflow being evaluated;
assigning a derived value to each range; and
assigning a range to each category pending evaluation input;
whereby standardized evaluation criteria are established for evaluating workflows.

16. The program product according to claim 15 wherein said method further comprises assigning a risk/complexity criteria adder to the overall evaluation.

17. The program product according to claim 15 wherein said method further comprises assigning an offset value to a particular category wherein said particular category is not adjusted by the number of assets.

18. The program product according to claim 15 wherein said method further comprises adding integration, verification, and test values to the evaluation of workflows.

19. The program product of claim 15 wherein said derived values comprise development values calculated by adding base line days to the sum of Development Integration Test (DIT) resources and the number of assets times an asset multiplier.

20. The program product of claim 15 wherein said method further comprises:
scoring said questions for a workflow to be evaluated;
calculating each question's score by multiplying the question's score times the weight assigned to the category for that question;
totaling the total score for each of said categories;
converting said total score for each category to a percentage of the weighted score;
using said percentage to retrieve a range value for said category;
using said retrieved range value to retrieve said base line days for said retrieved range value;
averaging together the total scores of all categories to give a total of days for the workflow being evaluated.

21. The program product of claim 15 wherein certain of said questions are removed from the calculation of the question's score by indicating said certain questions are indicated as being non-applicable.
